(19) United States
(12) Patent Application Publication
(10) Pub. No.: US 2010/0221532 A1
(43) Pub. Date: Sep. 2, 2010

(54) Method for Producing High Anisotropy Pressure-Sensitive Adhesives

(75) Inventors: Thilo Dollase, Hamburg (DE); Bernd Dietz, Ammersbek (DE); Klaus Keite-Telgenbuscher, Hamburg (DE)

Correspondence Address: Hildebrand, Christa;Norris McLaughlin & Marcus PA, 875 Third Avenue, 8th Floor, New York, NY, 10022, US

(73) Assignee: TESA AG, Hamburg (DE)

(21) Appl. No.: 12/090,923

(22) PCT Filed: Nov. 1, 2006
(86) PCT No.: PCT/EP2006/068018

§ 371 Date: May 21, 2008

(30) Foreign Application Priority Data
Nov. 10, 2005 (DE) 10 2005 054032.5

(51) Int. Cl. C09J 7/02; B05D 5/10; B05D 3/06

(52) U.S. Cl. 428/343; 427/208.4; 427/516

(57) ABSTRACT

The invention relates to a method for producing pressure-sensitive adhesives that have low or no anisotropy, the process elements including an adhesive supply system, an application unit and a placement element. A melt strip of the pressure-sensitive adhesive is produced between the outlet of the application unit and the point of placement on the placement element and is stretched. The invention is characterized by controlling the stretching of the pressure-sensitive adhesive in the free melt strip by adjusting an effective ratio G which is defined as the ratio of the effective time Δt of the stretching to the stretching rate R, and which is adjusted to a value of at least 0.006 s² or to a value of not more that 0.004 s². The effective time Δt is defined by the formula 2Lr/[vₛₜᵣᵢₚ(1+r)] wherein L is the length of the melt strip, r is the stretching ratio and vₛₜᵣᵢₚ is the speed of the melt strip and the stretching rate R is defined as a temporal derivative of the stretching ratio r.

The present invention relates to a method for producing pressure-sensitive adhesives (PSAs) of high anisotropy, comprising an adhesive supply system, suitable applicator mechanisms, and suitable placement elements, there being formed, during the operation, a free melt web of the PSA, which undergoes a draw operation. In accordance with the invention the draw operation on the free melt web is controlled via an activity ratio Γ which is characterized by the activity time in the draw operation, Δt, to the draw rate R. The invention further relates to the use of anisotropic PSAs produced according to the invention in pressure-sensitively adhesive products.

By virtue of their permanent tack, pressure-sensitively adhesive products find diverse fields of use such as, for example, in the processing industry and in private households. Depending on application there are different requirements concerning the combination of adhesive and cohesive properties of the PSA. The required profile of properties of a PSA, and hence its usefulness for one or more applications, can be controlled typically through the selection of the base materials and their formulation. Important constituents in a PSA formula are polymers of sufficiently low softening temperature and high molar mass, which give the PSA a suitable viscoelastic character. Examples that may be mentioned at this point include rubbers and polyacrylates. Moreover, the properties of PSAs can be varied through the setting of the state of crosslinking. This gives rise to diverse possibilities for making PSAs available for numerous such different requirements. A range of different pressure-sensitively adhesive products is offered, some of which can be used universally for many different applications and some of which are tailored to specific applications.

Besides the influence of the base materials, however, the processing of the PSA also affects the subsequent properties in the pressure-sensitively adhesive product. The reason for this is that the structure of the base materials in the coated PSA film may be different from one operation to the next or may differ according to the operational regime. This is a result of the flow profiles characteristic of a given processing operation, which can lead to deformation and orientation of constituents in the formulation that can be influenced in these respects, such as, more particularly, polymer chains, by shearing and/or extension [M. Pahl, W. GleiBle, H.-M. Laun, Praktische Rheologie der Kunststoffe and Elastomere, 4^{th} ed., 1995, VDI-Verlag, Düsseldorf, p. 337 et seq.]. One result of such deformation is the formation of oriented polymer chains [I. M. Ward in Structure and Properties of Oriented Polymers, I. M. Ward (ed.), 2^{nd} ed., 1997, Chapman & Hall, London]. The oriented state is associated with a structural anisotropy. By anisotropy is meant the circumstance that the value of a physical property of a medium has different values depending on the direction in which it is considered, and is not—as in the case of isotropy—the same when considered in every spatial direction. Of particular interest in this context are optical, electrical, magnetic or mechanical, but also adhesives-related, parameters.

Within an arbitrary processing operation the PSA system for processing is typically subject to laminar flow. Depending on the throughput and geometry of the space occupied by the PSA system or available to the PSA system, flow profiles arise which are based, to different extents, on shearing flows and/or extensional flows. The character of a shearing flow always prevails, ideally, when the external confines on the flow of the PSA, in other words, for example, the channel walls, during transport of the adhesive do not change over a path length under consideration. Tube flow may be one example of this ideal case. Extensional flow, in contrast, occurs whenever the flow confines converge or diverge. This is the case, for example, for all kinds of tapering of the adhesive's flow. Pure shearing flow and pure extensional flow, however, seldom prevail in actual operations. Instead, for the majority of the operating segments in an actual PSA coating operation, it is necessary to assume a superposition of shearing flow and extensional flow.

The production of pressure-sensitively adhesive products always includes a coating step in which the fluid PSA in the form, for example, of its melt or the solution or dispersion thereof is converted into a two-dimensional form. In the course of this processing step, shearing and/or extending influencing factors on the fluid under operation are manifested in a particularly pronounced way. In conventional methods, PSA solutions, for example, are applied by roll processes or blade processes to a continuously conveyed carrier material. In that case the solvent acts as an operating aid which sets the flow properties, i.e. the viscosity, but also the elasticity, of the material being processed, in such a way that coating results in a PSA layer of high surface quality. For reasons of cost and an increased environmental awareness, there is a trend toward reducing or eliminating entirely the volume of solvent used in the processing operation. In the past, therefore, coating processes have been developed in which it is possible to do without solvent—in some cases entirely. Technologies of this kind include hotmelt operations and extrusion operations in which the PSAs are processed from the melt. The high molecular mass polymer constituents in the PSA formulations for processing present particularly exacting requirements on these processes, owing to their property of exhibiting high melt viscosities. Examples of coating processes which are described for solvent-free coatings are disclosed in U.S. Pat. No. 3,783,072 by Johnson & Johnson, in DE 199 05 935 by Beiersdorf, and in U.S. Pat. No. 6,455,152 and EP 622 127 by 3M.

Many high-value applications use polyacrylate-based PSAs. In contrast to many other elastomers, polyacrylates offer the advantage that they can be flexibly adapted to a required profile of properties through free-radical addition polymerization and through the use of different comonomers. They are distinguished, moreover, by good resistance to various external influences. For polyacrylate-based PSAs as well, recent years have seen a trend toward solvent-free coating processes and toward PSA systems which can be coated solventlessly. Examples of these are described in U.S. Pat. No. 5,391,406 by National Starch, in EP 377 199 by BASF, in WO 93/09152 by Avery Dennison, in DE 39 42 232 and DE 195 24 250 by Beiersdorf, and in DE 101 57 154 by tesa AG.

In principle, all formulations which contain long-chain polymers have the potential to form anisotropic structures. Such structures may be generated by deformation, leading to chain stretching and molecular orientation. Important examples where the specific properties of oriented polymers are exploited include uniaxially oriented synthetic fibers and also monoaxially and biaxially oriented polymeric films. The purpose of deliberate stretching of the stated materials, in the case of such fibers and films, is primarily to optimize the stress/strain properties, such as, for example, the extensibility or the tear strength. Certain operations for generating orientation, and phenomena associated with orientation in polymeric films, and also options for the measurement of orientation, have been compiled by J. L. White and M. Cakmak [J. L. White, M. Cakmak, “Orientation”; “Orientation Processes”, in Encyclopedia of Polymer Science and Engineering, volume 10, H. F. Mark, N. M. Bikales, C. G. Overberger, G. Menges, J. I. Kroschwitz (ed.), 2nd ed., 1985, Wiley, New York]. For supplementation it is possible to consult Mills [P. J. Mills in Structure and Properties of Oriented Polymers, I. M. Ward (ed.), 2nd ed., 1997, Chapman & Hall, London].

One method of generating the desired orientation and hence structural anisotropy in thermoplastic polymeric films entails drawing a melt web, in other words the free mass film between coating assembly and deposition element. An operation of this kind is described, for example, in U.S. Pat. No. 6,299,821 by ExxonMobil, in DE 36 35 302 and in EP 515 863 by Hoechst, and in DE 33 26 056 by Clopay. Another process which allows orientation to be generated is to draw a free mass film by means of rolls which rotate at different speeds. This process is described, for example, in EP 523 542 by Hoechst. In the case of pressure-sensitive adhesives (PSAs) as well, it is possible to generate orientation through operations which involve drawing a melt web. However, the systems for processing, film formulations on the one hand and PSAs on the other, differ in their processing properties. Whereas thermoplastics, and more particularly those based on partly crystalline polymers, undergo at least partially physical crosslinking on cooling, there is no change in phase behavior on cooling in the case of elastomeric PSAs.

A number of processes described for producing anisotropic PSAs, such as DE 100 52 955 and DE 101 57 154 of tesa AG, for example, teach the possibility of using roll processes and melt die processes, the latter as contact processes or as non-contact processes, or, preferably, extrusion processes for this purpose. Important operational parameters which are specified, and which lead to the generation of orientation and, in some cases, anisotropy in the coated PSA film, include the drawing of the PSA film, the varying of the web speed, the layer thickness of the PSA film, the duration between coating step and chemical crosslinking, and the temperature of the coating roll, and also, in the case of die coating, additionally, the design of the shaping of the coathanger die and the lip distance at the exit from the die.

Accordingly it is possible to utilize with advantage the effect of the processing operation and more particularly its orienting effect on the properties for pressure-sensitive adhesive products as well. DE 100 52 955 to tesa AG describes the use of anisotropic PSAs for diecut products. In that case, extrusion of a melt produces structural anisotropy which can be “frozen in” in the crosslinking operation that follows the coating procedure. This gives PSAs with mechanical anisotropy which can therefore be used with advantage in specific applications. Furthermore, U.S. Pat. No. 5,866,249 and U.S. Pat. No. 6,632,522 to 3M describe anisotropic PSAs which have bond strengths dependent on take-off direction, and therefore appear to be of interest for other specific applications. For specific applications and innovative properties, therefore, the existence of anisotropic PSAs is particularly attractive.

It was an object of the invention, therefore, to develop production methods which allow anisotropy to be generated to as high a degree as possible in PSAs. The intention is to provide methods which make it possible in a more pronounced way to generate higher anisotropy in PSA films than has been the case in the processes of the prior art.

It has surprisingly been found that this object can be achieved if the methods for producing PSAs are controlled in the orienting operation by an advantageously set defined ratio Γ which is characterized by activity time Δt of the draw process to the draw rate R in the melt web.

Hence it is possible, surprisingly, to produce oriented PSAs in which the stretching process in the melt web during coating is designed in an innovative way through the setting of the activity ratio Γ, and so leads to an optimized generation of anisotropy. By way of the method of the invention, as additionally set out in detail in the description, the examples, and the claims, pressure-sensitively adhesive products comprising PSAs of heightened anisotropy are produced in an advantageous way.

The method of the invention for producing PSAs with a high degree of anisotropy comprises an adhesive supply system involving supply of the individual components of a pressure-sensitive adhesive system, including suitable mixing and conveying assemblies, suitable applicator mechanisms, and placement elements. In accordance with the invention it is possible, for the production of PSAs, to employ any processing operations that produce a free melt web (a melt film). Preference is given to employing the solvent-free melt-mixing and coating of a carrier material. The free melt web is formed between the exit from the applicator mechanism and point of placement on the deposition element, where it generally undergoes a draw operation. In accordance with the invention the method is characterized in that the draw operation on the free melt web is selectively influenced via the activity ratio Γ which is characterized by the activity time in the draw operation, Δt, relative to the draw rate R; in this way the production of PSAs of high anisotropy can be controlled.

The activity time Δt is defined by the formula 2Lr/[v_{web}(1+r)], in which L is the length of the melt film, r is the draw ratio, and v_{web} is the velocity of the melt film. The draw rate R is defined as the time derivation of the draw ratio r. The individual components will be addressed in more detail later on below.

The method for producing high-anisotropy PSAs is preferably carried out by choosing the parameters in such a way that the activity ratio Γ is high and possesses a value of at least 0.006 s², preferably of at least 0.008 s².

In one further version of the invention the ratio value ought to be chosen to be small and ought to amount to not more than 0.004 s², preferably not more than 0.002 s².

The inventive production of anisotropic PSAs employs coating operations which comprise an adhesive supply system, an applicator mechanism, a medium on which the PSA film is deposited, and optionally a crosslinking station.

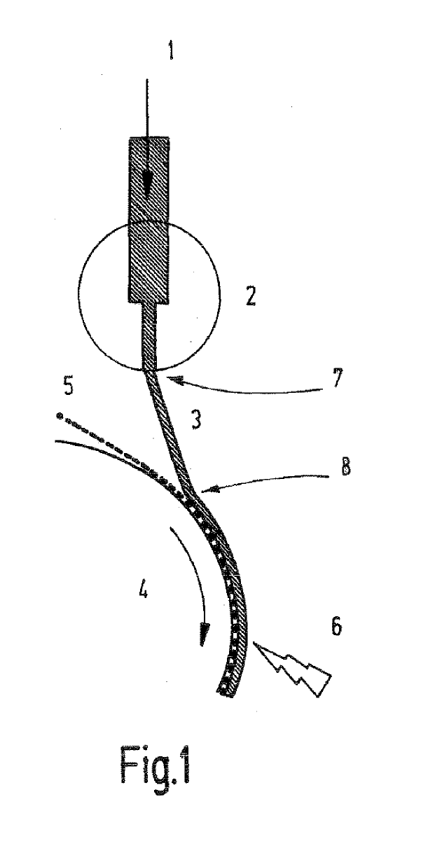

FIG. 1 shows, diagrammatically, various preferred operating segments, details of which are given in the present description and which symbolize the method sequence according to the invention. Reference numerals in the figure are defined as follows:

(1) adhesive supply line;
(2) applicator mechanism or coating assembly;
(3) melt web;
(4) cooling roll;
(5) optionally employable, separately supplied deposition medium;
(6) optionally employable crosslinking station;
(7) exit slot;
(8) point of placement.

Detail (8) should be understood as a projection of the placement line that is actually present, resulting from the deposition of the melt web—i.e., in principle, of one surface—to another surface, namely the surface of a cooling roll or of the optionally employable deposition medium.

The diagrammatic representation in FIG. 1 is a preferential variant and should not be understood as an exclusive configuration of this invention. Instead, the siting of individual segments relative to one another, and also their form, may be different from what is shown. Angles and dimensions are not to scale.

The methods of the invention relate to all PSA processing operations in which a melt web is involved during the coating operation. By a melt web (detail (3) in FIG. 1) is meant, for the purposes of this invention, a PSA film which is free on at least two sides and which is located between the exit slot (detail (7)) of the applicator mechanism or coating assembly (detail (2)) on the one hand and the point of placement (detail (8)) on the deposition element on the other hand. By deposition element is meant, for the purposes of this invention, detail (4), optionally in combination with detail (5). Through the choice of a difference in velocity between the mass flow on exit from the applicator mechanism and the point of placement, a draw operation takes place. This draw operation is associated with a more or less pronounced deformation of the PSA film. The nature of this deformation is determined essentially by extension. The drawing of films can be utilized in order to set layer thicknesses when there are not exit slots available with the desired dimensions or where smaller exit slots are not used for other reasons, such as an impermissible buildup of pressure in the coating assembly, for example. Additionally, however, within the film, there is also molecular orientation of structurally anisotropic formulation constituents and also chain stretching of flexible polymer molecules, thereby resulting in an anisotropic PSA film. The anisotropy reaches a maximum value at the point of placement. Through the method of the invention, this maximum value of the anisotropy at the point of placement is maximized further, leading to an improvement in the anisotropic properties of the PSA and/or one or more of its constituents.

In the methods of the invention, the PSA is subjected, during the coating step, within the melt web, substantially to a planar extension. For a planar extension operation on an incompressible fluid it is the case that that dimension of a volume element of the fluid that is parallel to the direction of extension (given in the method by the machine direction) increases in the same proportion by which another dimension is reduced (in the operation, the normal direction, film thickness), while the third dimension (in the operation, the transverse direction, web width) remains unchanged. Such a drawing of the melt web is in this case given by the ratio of the exit slot D (detail (7) in FIG. 1) of the applicator mechanism to the layer thickness d of the PSA film at the point of placement (detail (8) in FIG. 1). This ratio may here be called the draw ratio r, where

r=D/d=v_{web}/v₀ (1)

In equation (1) v_{web} is the web velocity and v₀ is the velocity of the PSA film at point (7). The higher the value of the draw ratio, the higher the extensional stress on the PSA film in the melt web. This illustrates the qualitative influence of the layer thickness of the PSA film at the point of placement and of the exit slot of the applicator mechanism. In one version of the invention, therefore, the draw ratio parameter is preset such that it too gives rise to a large effect in terms of the generation of high orientation and chain stretching. In one preferred embodiment of the inventive method the parameters of the height of the die slot, D, and layer thickness d of the PSA film at the point of placement are selected so as to result in as high a draw ratio as possible. Draw ratios in accordance with the invention are at least 2:1, preferably at least 4:1, very preferably at least 6:1.

Draw ratios of this kind are preferably realized through a particularly large exit slot D. For the purposes of this invention this exit slot is preferably at least 150 μm in size, more preferably at least 300 μm in size, very preferably at least 600 μm in size.

The layer thickness d of PSAs is dependent on the desired product and is generally preferably between 1 μm and 2000 μm, more preferably between 5 μm and 1000 μm.

TABLE 1

| Parameter | Symbol | Definition |
|---|---|---|
| Activity time | Δt | Residence time of the PSA in the |
| | | melt web. |
| Draw rate | R | Time derivation of the draw ratio. |
| Inventive activity | Γ = Δt/R | Ratio of activity time to draw |
| ratio | | rate. |
| Plateau modulus | G_{N}⁰ | Storage modulus in the rubber- |
| | | elastic regime. Material-specific |
| | | parameter. |
| Longest relaxation | T_{D} | Disentanglement time. Material- |
| time | | specific parameter. |
| Degree of | Z | Number of entanglements per chain. |
| entanglement | | Material-specific parameter. |
| Maximum chain | λₘₐₓ | Material-specific parameter. |
| stretchability | | |
| Layer thickness | d | Film thickness of the PSA film at |
| | | the point of placement of the |
| | | deposition element. |
| Exit slot | D | Film thickness of the PSA film on |
| | | exit from the coating assembly. |
| Draw ratio | r | Ratio of exit slot of the |
| | | applicator mechanism to the layer |
| | | thickness of the PSA film at the |
| | | point of application of the |
| | | placement medium. |
| Web velocity | v_{web} | Transport velocity of the |
| | | deposition medium. |
| Initial velocity | v₀ | Velocity of adhesive on exit from |
| | | the applicator mechanism (point |
| | | (7) in FIG. 1). |
| Length of melt web | L | Length of the free PSA film |
| | | between points (7) and (8) in |
| | | FIG. 1. |
| Chain stretching | Λ | Measure of anisotropy. |
| Molecular | Ω | Ratio of preferential orientation |
| orientation | | of the longitudinal ellipsoid axes |
| | | along the machine direction to |
| | | preferential orientation along the |
| | | transverse direction. Measure of |
| | | anisotropy. |

In actual fact the planar extension represents an ideal case for deformation that occurs. In actual operations a reduction in layer thickness is typically accompanied by a certain contraction of the PSA film during drawing, in other words a tapering in the width of the PSA layer after exit from the coating assembly. If the amount of this neck-in is small in comparison to the web width in coating operations, then the draw operation can be described in good approximation by way of the formalism of planar extension. All those operations which include the drawing of a melt web and which, furthermore, exhibit neck-in on the part of the PSA film are also according to the invention.

A preferred inventive variable which can be used with particular advantage in order to lead the anisotropy, in PSAs in coating operations, to increased values has been found, surprisingly, to be the length of the melt web. This process variable influences firstly the residence time of the PSA in the melt web, Δt (“activity time”), and also, secondly, the draw rate R. In accordance with the invention, therefore, influence over these two process variables is exerted preferably via the length of the melt web, thus producing maximum anisotropy values for PSAs. The advantageous possibility, found surprisingly, of utilizing the length of the melt web to solve the problem of providing PSAs of heightened anisotropy will be underscored and made plausible in the further course of this description by means of a formula-based approach.

The inventive approach of using, more particularly, the length of the melt web as a variable is particularly advantageous since its length is readily adjustable from a technical standpoint, namely, before the beginning of the operation, by running up the applicator mechanism to a corresponding position relative to the deposition medium, while other operational parameters such as, for example, the web velocity may often be limited by other invariables, such as, for example, the radiation dose which can be achieved in the crosslinking station. It is likewise in accordance with the invention for two or more parameters to be changed at one and the same time, these parameters always including the length of the melt web. In this way, therefore, different settings are possible, all of which are preferred, advantageous embodiments of the method of the invention.

It has already been stated that the length of the melt web influences two process variables, namely the activity time and the draw rate. These two process variables differ in their influence on the development of anisotropy in PSAs during processing. Consequently the length of the melt web can be utilized inventively in two ways.

Part of this invention, therefore, are versions of a method in which the length of the melt web in the operation is specified as being particularly long. In this case, influence is exerted advantageously on the activity time Δt, as will be set out with greater precision in the further course of the description. An inventively long melt web leads to activity times that tend to be higher. An increased activity time allows the development of higher degrees of anisotropy in PSAs.

Within the activity time Δt, the deforming nature of the draw operation offers the possibility for interaction with the PSA or with one or more of its constituents, and hence of acting to generate anisotropy. It is therefore possible to make advantageous use, for the purposes of this invention, also of all those coating operations which feature a particularly long residence time of the PSA during the draw operation, in other words in the melt web. The longer the melt web, the longer too is the activity time Δt, for a constant web velocity.

The variable which makes this approach according to the invention plausible is the time increment during which one volume element of the PSA is located in the melt web. In this context this time increment is designated the activity time Δt and, for the point of placement (detail (8) in FIG. 1) is given by

Δt=2Lr/[v_{web}(1+r)] (2).

In equation (2), L is the length of the melt web, v_{web} is the web velocity, and r is the draw ratio. Equation (2) can be derived from considerations relating to the uniformly accelerated motion (on this point see, for example, H. Stöcker (ed.), Taschenbuch der Physik, 2nd edition, 1994, Verlag Harri Deutsch, Frankfurt a.M., p. 12). Principles are formed by the two laws of motion

s(t)=at²/2+v₀t+s₀ (3)

and

v(t)=at +v₀ (4)

where s(t) is the time-dependent spatial coordinate, a is the acceleration, v₀ is the velocity at the beginning of the operation under consideration, in other words when the PSA film exits the coating assembly, sₒ is set=0 and v(t) is the time-dependent velocity. By using equation (4) it is possible to eliminate a in equation (3). If the point of placement (8) in FIG. 1 is considered, then t becomes Δt, s(t=Δt) becomes L and v(t=Δt) becomes v_{web}. Using these boundary conditions, the result, after a certain amount of algebra, is

L=V_{web}Δt(r+1)/2r (5),

from which it is possible to derive equation (2) as the determining equation for the activity time. The formalism specified here is intended to serve to illustrate the intention of this invention. To the skilled worker it is obvious that draw operations may deviate from the ideal case of uniformly accelerated motion. Accordingly not only those methods which correspond fully to the description above but also those which are defined by the further observations in this description and in the claims are inventive.

For the purposes of the invention, it is particularly advantageous also, where appropriate, to optimize the setting of all other operational parameters which have a positive influence on the generation of anisotropy. An example that may be mentioned in this context is a high draw ratio. This inventive embodiment can be further developed, in an advantageous way, by using, in the operation, a web velocity which has been reduced to an optimum degree, in combination with a throughput which has likewise been reduced and has been adapted in a suitable way to the web velocity, with the consequence that these method parameters as well increase the activity time. The particularly long melt web then allows these influencing parameters to have an optimum activity on the PSA or one or more of its constituents, so that advantageously high degrees of anisotropy can be generated by way of this inventive path.

According to the invention the activity time is preferably at least 0.01 s, more preferably at least 0.1 s, very preferably at least 0.25 s.

For the purposes of the invention the length of the melt web amounts preferably to greater than 40 mm, more preferably greater than 75 mm, very preferably greater than 100 mm.

In the above-described preferred concept of this invention, the influence of the length of the melt web on the anisotropy generation in PSAs was shown. In that sense a particularly long melt web has already been mentioned as advantageous within the meaning of the invention.

However, in a further advantageous embodiment of this invention, it is also possible to realize the desired optimum anisotropy generation in PSAs by employing a particularly short melt web.

Also part of this invention, therefore, are methods in which the length of the melt web is configured so as to be particularly short. In this case influence is preferably exerted on the draw rate R, as becomes clear in the further course of the description. A short melt web length leads to increased draw rates. By way of higher draw rates it is therefore possible, in accordance with the invention, to generate increased degrees of anisotropy in PSAs.

The draw rate R has an influence on the degree of generated anisotropy on the part of the PSA at the point of placement, since it acts directly on the time profile and on the effectiveness of the extension operation, and hence on the deformation of the PSA film. The higher the draw rate, the higher the degree of anisotropy which can be achieved in principle. In one preferred embodiment of this invention the generation of anisotropy in the PSA film is controlled via the draw rate and in this case specifically also by the setting of the length of the melt web. Generally speaking, the draw rate represents the time derivation of the draw ratio r. For the point of placement (detail (8) in FIG. 1) it can be reproduced by

R=v_{web}(r−1)/(Lr) (6),

where v_{web} describes the velocity of the deposition medium, L the length of the melt web, and r the draw ratio. Like equation (2) before it, equation (6) as well, results from considerations on uniformly accelerated motions. The draw rate R, at the point of placement (detail (8) in FIG. 1), at which t=Δt, s(t=Δt)=L, and v(t=Δt)=v_{web}, depends only on the differential velocity which prevails within the melt web, i.e., Δv=v_{web}−v₀. For this point it is possible to formulate

R=Δv/L=(v_{web}−v₀)/L (7).

Instead of v₀, v_{web}/r is used, thereby resulting, finally, in equation (6). As for the activity time before, the formalism presented here is based on the assumption that the inventive operation can be represented by a uniformly accelerated motion. However, this observation serves merely to underpin and to elucidate the intention of this invention. The use of this formalism for this purpose does not restrict the amount of the inventively employable operations to those methods which can be fully described by way of it. Instead, other methods are also in accordance with the invention and in fact all those which are defined by the further observations in the description and the claims.

For the purposes of the invention it is particularly advantageous, for the purpose of generating high anisotropy, to give an optimized setting, preferably, to all of the other operating parameters as well that have a positive influence thereon. An example that may be mentioned in this respect is a high draw ratio. Instead of this or else in addition it is also possible, advantageously, to select a high web velocity.

In accordance with the invention, draw rates are employed that are preferably at least 1 s⁻¹, more preferably at least 10 s⁻¹, very preferably at least 25 s⁻¹.

For the purposes of this invention, in this preferred embodiment of the invention, the length of the melt web is less than 40 mm, preferably less than 25 mm, very preferably less than 15 mm.

In the above part of this description it has been shown how it is possible to exert influence on the generation of anisotropy in PSAs in a novel and advantageous way via the length of the melt web in a coating operation. The length of the melt web has a different effect on the parameters of activity time and draw rate, which both, either individually or in combination with the other one, and/or, optionally, also in combination with further method parameters, lead to the development of anisotropy in PSAs. As already remarked, these two parameters can now be united to give the new criterion, the inventive activity ratio Γ, which is given by

Γ=Δt/R (8).

If the respective determining equations for the activity time, equation (2), and the draw rate, equation (7), are inserted into equation (8), then Γ takes on the following form:

Γ=2(Lr)²/[v_{web}²(r²−1)] (9).

In accordance with the observations made above, an increase in the activity time produces higher degrees of anisotropy. Similarly, an increase in the draw rate also leads to higher degrees of anisotropy. According to equation (8), therefore, coating operations that are inventive for PSAs are all those which are described by particularly large Γ values, and also those operations which are characterized by particularly low Γ values.

All coating operations for PSAs for which it is possible to formulate an inventive activity ratio Γ of at least 0.006 s², preferably of at least 0.008 s², in accordance with the observations and approximations made above are in accordance with the invention.

Also in accordance with the invention are all those coating operations for PSAs for which it is possible to formulate an inventive activity ratio Γ of not more than 0.004 s², preferably of not more than 0.002 s², in accordance with the observations and approximations given above.

Equation (9) shows clearly the influence of the length of the melt web, L, on the inventive activity ratio. Moreover, it is evident from equation (9) that the method parameters of web velocity, v_{web}, and draw ratio r also have an important influence on the inventive activity ratio Γ. These parameters are therefore selected advantageously in combination with the length of the melt web in the coating operation in such a way that they too produce an optimum effect on Γ and hence the generation of anisotropy in PSAs.

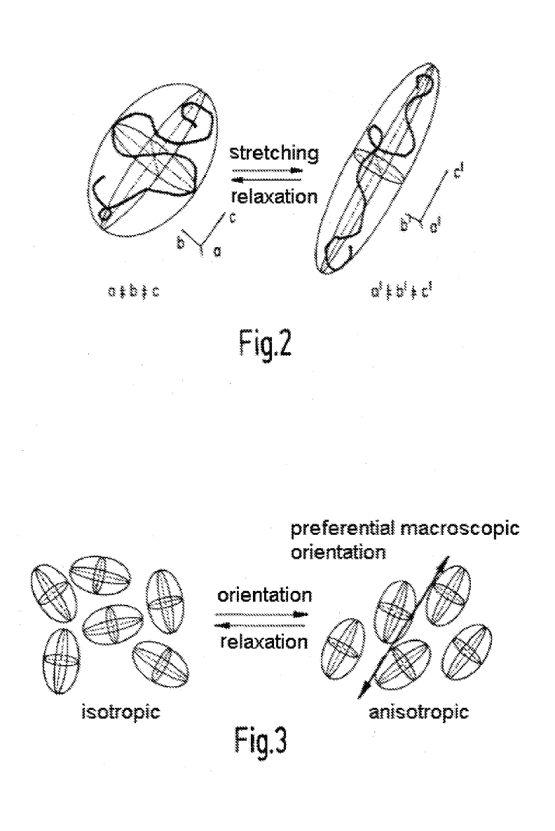

The present invention relates advantageously preferably to PSAs which in the raw state, in other words in the chemically or radiation-chemically uncrosslinked state, represent nonnewtonian fluids, and more particularly, specifically, represent nonnewtonian fluids which are structurally viscous in nature. Nonnewtonian fluids exhibiting structural viscosity are distinguished by the fact that, above critical shear rates, they exhibit a shear-rate-dependent viscosity. Structurally viscous behavior is connected with a change in the structure of individual constituents of the formulation, more particularly of long-chain polymers, when there are changes in the flow state. For polymers this behavior can be described on a model basis to mean that, in accordance with the state of flow, the molecular structure changes so as to attain a flow resistance which is lower than that of the undeformed polymers. This is accomplished on the one hand by the stretching of individual chains and also by molecular orientation. The envelope of a polymer chain can be represented in general terms by an ellipsoid. Chain stretching is linked with a change in the ellipsoid geometry, such as an elongation, for example (FIG. 2), orientation with the alignment of two or more such ellipsoids along a preferential direction (FIG. 3). Possibilities for the quantification of chain stretching and molecular orientation, and the matter of how these variables can be utilized as a criterion for anisotropy, are addressed in the “Examples” section. If there is a change in the state of flow, then the structure of the polymer chains and the orientation adapt to the new circumstances. Opposing orientation operations and chain stretching events are relaxation processes, with the consequence that, if the flow process is halted without further external stimulation, a restructuring of the PSA occurs and, as a consequence of this, the state regains the structural equilibrium which prevailed before the beginning of the flow operation. However, this “reverse reaction” takes place only if the system retains a certain internal mobility. Critical to the orientation, chain-stretching, and relaxation behavior of polymers in PSAs is the nonlinear rheological behavior under steady-state conditions, but also under transient conditions—since in actual operations the PSA system typically moves in a changing flow profile. In good approximation, the rheological behavior of such PSAs is described by four material parameters: the plateau modulus G_{N}⁰, the longest relaxation time T_{D}, the degree of entanglement per polymer chain Z, and the maximum chain stretchability λₘₐₓ. A more precise description of these variables is given by Fang et al. [J. Fang, M. Kröger, H. C. Ottinger, J. Rheol., 2000, 44, 1293].

In general the anisotropic state is characterized by the existence of orientation and chain stretching. The degree of anisotropy that can be achieved depends on the nature and composition of the PSA. Not only because the orientation and relaxation phenomena described here, like all rheological processes, are significantly temperature-dependent, the temperature represents a further important influencing variable for the evolution and the possible abatement of anisotropy. For the purposes of this invention, coating is carried out preferably at extremely low temperatures. Coating temperatures according to the invention depend on the nature of the PSA to be coated, and are selected such that the material is located within a structurally viscous flow regime as it departs the coating assembly. Such coating temperatures are located typically at between 25° C. and 250° C., preferably between 50° C. and 200° C. The temperature of the cooling roll (detail (4) in FIG. 1) is likewise chosen to be as low as possible. Preferred temperatures of not more than 60° C., preferably of not more than 30° C., are inventive. In one embodiment of the invention it is advantageous if the PSA film is cooled at any desired point in time after having departed the applicator mechanism, preferably using a cooling medium of any desired kind and/or a cooling assembly of any desired kind.

In the method of the invention the supply of adhesive is accomplished by means of assemblies typical per se for conveying viscous media, preferably by extruders that are customary in plastics processing and in the adhesive tape industry, or other suitable assemblies for softening/melting and conveying thermoplastic media. These may be, for example, typical adhesive-industry drum melters, premelters, melt pumps or other melting and conveying systems, with combinations of different such elements also being useful. The term extruder for the purposes of this description also comprehends other suitable abovementioned melting and conveying systems. Also applicable in accordance with the invention is the combination of extruder and melt pump, which in this case can be used with advantage for improving the consistency of conveying. Suppliers of melt pumps of this kind include, for example, the companies Maag (Zurich, Switzerland) or Witte (Itzehoe, Germany).

A preferred application method used for the purposes of this invention is a slot die. The types of extrusion die used with great preference in accordance with the invention are subdivided into the categories of T-dies, fishtail dies, and coathanger dies. The stated types differ in the design of their flow channel, resulting in different residence times and distribution strategies. For producing anisotropic coatings based on polyacrylates it is preferred to employ coathanger dies, of the kind offered, for example, by the companies Extrusion Dies, Inc. (Chippewa Falls, USA) or Reiffenhäuser (Troisdorf, Germany). For the purposes of the invention, however, it is also possible to employ other coating methods which operate with a melt web, such as the hotmelt curtain coating method (Inatech, Langenfeld, Germany or Nordson, Luneburg, Germany), for example. Reference is also to combinations of an extrusion die and a calender method or derived roll application methods, such as smoothing rolls or other assemblies with a melt web that, by means of an extrusion die, utilize melt premetering into a calender nip. Examples here would include roller-head units from Troester, Hanover, or polymer-film units and plastic-sheet units from Kuhne, St Augustin.

The PSA film spread out in flat form is deposited preferably in the method in accordance with the invention onto a carrier material or release material.

For producing the carrier film it is possible in principle to use all film-forming and extrudable polymers. One preferred embodiment uses polyolefins. Preferred polyolefins are prepared from ethylene, propylene, butylene and/or hexylene; in each case, it is possible to polymerize the pure monomers, or mixtures of the stated monomers are copolymerized. Through the polymerization process and through the selection of the monomers it is possible to control the physical and mechanical properties of the polymer film, such as the softening temperature and/or the tear strength, for example.

A further preferred embodiment of this invention uses polyvinyl acetates. Polyvinyl acetates may include vinyl alcohol as a comonomer besides vinyl acetate, with the free alcohol fraction being widely variable. A further preferred embodiment of this invention uses polyesters as carrier film. One particularly preferred embodiment of this invention uses polyesters based on polyethylene terephthalate (PET). A further preferred embodiment of this invention uses polyvinyl chlorides (PVC) as film. To raise the temperature stability, the polymer constituents of these films may be prepared using stiffening comonomers. Furthermore, in the course of the inventive operation, the films may be radiation-crosslinked in order to obtain such improvement in properties. Where PVC is employed as a film base material, it may optionally comprise plasticizing components (plasticizers). One further preferred embodiment of this invention uses polyamides for producing films. The polyamides may be composed of a dicarboxylic acid and a diamine or of two or more dicarboxylic acids and diamines. Besides dicarboxylic acids and diamines it is also possible to use higher polyfunctional carboxylic acids and amines, both alone and in combination with the abovementioned dicarboxylic acids and diamines. To stiffen the film it is preferred to use cyclic, aromatic or heteroaromatic starting monomers. One further preferred embodiment of this invention uses polymethacrylates for producing films. In this case it is possible through the choice of the monomers (methacrylates and also, in some cases, acrylates) to control the glass transition temperature of the film. Furthermore, the polymethacrylates may also comprise additives, in order, for example, to increase the flexibility of the film or to raise or lower the glass transition temperature, or to minimize the formation of crystalline segments. One further preferred embodiment of this invention uses polycarbonates for producing films. Further, in one further embodiment of this invention, polymers and copolymers based on vinylaromatics and vinylheteroaromatics may be used to produce the carrier film. To produce a filmlike material it may also be appropriate here to add additives and further components which improve the film-forming properties, reduce the tendency for crystalline segments to form and/or selectively improve or even, where appropriate, impair the mechanical properties.

To produce the preferred release film which can be used it is likewise possible in principle to use all film-forming and extrudable polymers. In one preferred embodiment of the invention the release film is composed of a carrier film provided on both sides with a release varnish, which is based preferably on silicone. In one very preferred embodiment of the invention the release varnishes are graduated, i.e., the release values differ on the top and bottom faces. This ensures that the double-sided pressure-sensitively adhesive product or intermediate can be unwound. One preferred embodiment of this invention uses polyolefins as carrier material for the release film. Preferred polyolefins are prepared from ethylene, propylene, butylene and/or hexylene, it being possible in each case to polymerize the pure monomers or to copolymerize mixtures of the stated monomers. Through the polymerization process and through the selection of the monomers it is possible to control the physical and mechanical properties of the polymer film, such as the softening temperature and/or the tear strength, for example.

Also suitable as carrier material for release materials are diverse papers, optionally also in combination with a stabilizing extrusion coating. One or more coating passes with, for example, a silicone-based release give all of the stated release carriers their antiadhesive properties. The application may take place to one or both sides.

The film that is formed in the coating die is placed onto the carrier material or release material, called simply carrier material below, in a distance coating operation. In this operation the distance between the exit point on the applicator mechanism and the point of placement on the placement element is greater than the layer thickness at the point of placement. A melt web is formed whose geometry is laid down by the distance between the exit point of the applicator mechanism (detail (7) in FIG. 1) and the point of placement (detail (8) in FIG. 1) on the deposition element, optionally on the carrier material. The placement line is generated by a customary placement technique—this may take place, for example, via a suitable air knife, by a vacuum box, where appropriate in combination with an air knife, or via electrostatic placement devices. The carrier thus coated is preferably guided over a driven roll which can be cooled or heated. Alternatively, the melt web can be placed on arrangements such as conveyor belts, antiadhesively coated rotating elements, or rolls provided with a fluid coat, for example, and transferred to the carrier material in a downstream transfer unit (“laminating station”).

The methods of the invention may optionally include a thermal tunnel, thereby allowing the coated PSA film to be exposed to a temperature. Heat is supplied, for example, by electrical heating and/or infrared radiation. Preferably, for the purposes of this invention, no heating takes place between the placement of the melt web onto the deposition medium and a crosslinking step, in order not to accelerate the relaxation of the anisotropic state that has been generated.

It is particularly advantageous for the coating step to be followed, where appropriate, by a crosslinking step which ensures that the anisotropic state of the PSA film is “frozen in” before relaxation to a pronounced extent can lead to this state being abated. For the same purpose it is also possible to employ a crosslinking step during the coating step. Methods which can be used to particularly good effect are radiation-chemical crosslinking methods which utilize UV radiation and/or electron beams. An important factor in this case is the time which elapses between the deposition of the free PSA film on the deposition medium and the moment of crosslinking, since, within this period of time, relaxation occurs. A crosslinking station is integrated in the operation inventively when the crosslinking operation acts on the PSA film after a time span between exit of adhesive from the applicator mechanism and crosslinking of not more than 25 s, preferably not more than 10 s. It is possible, however, to employ any form of thermal crosslinking, including different forms of such crosslinking, both alone and in combination with radiation-chemical crosslinking processes in order to fix the anisotropy.

As pressure-sensitive adhesives (PSAs) it is possible to employ all linear, star-shaped, branched, grafted or otherwise-architectured polymers, preferably homopolymers, random copolymers or block copolymers, which have a molar mass of at least 100 000 g/mol, preferably of at least 250 000 g/mol, very preferably of at least 500 000 g/mol. Preference is given to a polydispersity, formed as the ratio of mass average to number average in the molar mass distribution, of at least 2. Preference is also given to a softening temperature of less than 20° C. The molar mass in this context is the weight average of the molar mass distribution, as is accessible, for example, by way of gel permeation chromatography analyses. By softening temperature in this context is meant the quasistatic glass transition temperature for amorphous systems, and the melting temperature for semicrystalline systems; these can be determined, for example, by dynamic differential calorimetry measurements. Where numerical values are reported for softening temperatures, they refer to the midpoint temperature of the glass stage in the case of amorphous systems, and to the temperature at maximum heat change during the phase transition in the case of semicrystalline systems.

As PSAs it is possible to use all of the PSAs known to the skilled worker, more particularly systems based on acrylate, natural rubber, synthetic rubber or ethylene-vinyl acetate. Combinations of these systems are also in accordance with the invention.

Without wishing to impose any restriction, examples that may be given of systems that are advantageous for the purposes of this invention include random copolymers starting from unfunctionalized α,β-unsaturated esters, and random copolymers starting from unfunctionalized alkyl vinyl ethers. Preference is given to using α,β-unsaturated alkyl esters of the general structure

CH₂═CH(R¹)(COOR²) (I)

where R¹ is H or CH₃ and R² is H or linear, branched or cyclic, saturated or unsaturated alkyl radicals having to 30, more particularly having 4 to 18, carbon atoms.

Monomers which are used very preferably in the sense of the general structure (I) include acrylic and methacrylic esters with alkyl groups consisting of 4 to C atoms. Specific examples of corresponding compounds, without wishing to be restricted by this enumeration, are n-butyl acrylate, n-pentyl acrylate, n-hexyl acrylate, n-heptyl acrylate, n-octyl acrylate, n-nonyl acrylate, lauryl acrylate, stearyl acrylate, stearyl methacrylate, their branched isomers, such as 2-ethylhexyl acrylate and isooctyl acrylate, for example, and also cyclic monomers, such as cyclohexyl or norbornyl acrylate and isobornyl acrylate, for example.

Likewise possible for use as monomers are acrylic and methacrylic esters which contain aromatic radicals, such as phenyl acrylate, benzyl acrylate, benzoin acrylate, phenyl methacrylate, benzyl methacrylate or benzoin methacrylate, for example.

It is additionally possible, optionally, to use vinyl monomers from the following groups: vinyl esters, vinyl ethers, vinyl halides, vinylidene halides, and also vinyl compounds which contain aromatic rings or heterocycles in α position. For the vinyl monomers which can optionally be employed, mention may be made, exemplarily, of selected monomers which can be used in accordance with the invention: vinyl acetate, vinylformamide, vinylpyridine, ethyl vinyl ether, 2-ethylhexyl vinyl ether, butyl vinyl ether, vinyl chloride, vinylidene chloride, acrylonitrile, styrene, and α-methylstyrene.

Further monomers which can be used in accordance with the invention are glycidyl methacrylate, glycidyl acrylate, allyl glycidyl ether, 2-hydroxyethyl methacrylate, 2-hydroxyethyl acrylate, 3-hydroxypropyl methacrylate, 3-hydroxypropyl acrylate, 4-hydroxybutyl methacrylate, 4-hydroxybutyl acrylate, acrylic acid, methacrylic acid, itaconic acid and its esters, crotonic acid and its esters, maleic acid and its esters, fumaric acid and its esters, maleic anhydride, methacrylamide and also N-alkylated derivatives, acrylamide and also N-alkylated derivatives, N-methylolmethacrylamide, N-methylolacrylamide, vinyl alcohol, 2-hydroxyethyl vinyl ether, 3-hydroxypropyl vinyl ether, and 4-hydroxybutyl vinyl ether.

In the case of rubber, or synthetic rubber, as starting material for the PSA there are further possibilities for variation, whether from the group of the natural rubbers or the synthetic rubbers, or whether from any blend of natural rubbers and/or synthetic rubbers, it being possible to choose the natural rubber or natural rubbers in principle from all available grades such as, for example, crepe, RSS, ADS, TSR or CV types, depending on the required level of purity and viscosity, and to choose the synthetic rubber or synthetic rubbers from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA), and polyurethanes and/or blends thereof.

Additionally, it is possible for the processability of rubbers to be improved by admixing them preferably with thermoplastic elastomers, with a weight fraction of 10% to 50% by weight, based on the total elastomer fraction. Representatives that may be mentioned at this point include especially the particularly compatible types polystyrene-polyisoprene-polystyrene (SIS) and polystyrene-polybutadiene-polystyrene (SBS).

As tackifying resins for optional use it is possible without exception to use all tackifier resins that are already known and have been described in the literature. As representatives mention may be made of the rosins, their disproportionated, hydrogenated, polymerized, and esterified derivatives and salts, the aliphatic and aromatic hydrocarbon resins, terpene resins, and terpene-phenolic resins. Any desired combinations of these and further resins may be used in order to set the properties of the resultant adhesive in accordance with requirements.

As plasticizers likewise for optional use it is possible to use all of the plasticizing substances known from self-adhesive tape technology. These include, among others, the paraffinic and naphthenic oils, (functionalized) oligomers such as oligobutadienes and oligoisoprenes, liquid nitrile rubbers, liquid terpene resins, vegetable and animal fats and oils, phthalates, and functionalized acrylates. PSAs of the kind indicated above may also comprise further constituents such as additives with rheological activity, catalysts, initiators, stabilizers, compatibilizers, coupling reagents, crosslinkers, antioxidants, other aging inhibitors, light stabilizers, flame retardants, pigments, dyes, fillers and/or expandants and also, optionally, solvents.

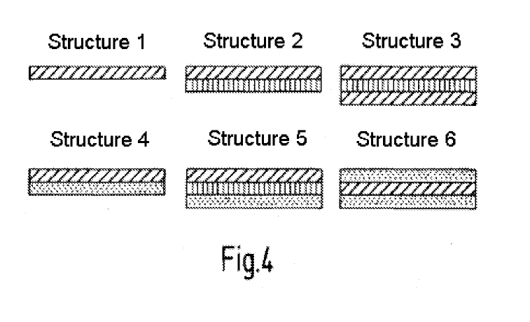

The anisotropic PSAs produced by the methods of the invention can be utilized for the purpose of constructing different kinds of pressure-sensitively adhesive products. Inventive structures of pressure-sensitively adhesive products are shown in FIG. 4. Each layer in the inventive structures of pressure-sensitively adhesive products can optionally be foamed.

At its most simple, a pressure-sensitively adhesive product of the invention is composed of the PSA in a single-layer structure (structure 1). Structure 1 may optionally be lined on one or both sides with a release liner, such as a release film or release paper, for example. The layer thickness of the PSA is typically between 1 μm and 2000 μm, preferably between 5 μm and 1000 μm.

The PSA may also be situated on a carrier, more particularly on a film or paper carrier (structure 2). In this case the carrier may have been given a prior-art pretreatment on the side facing the PSA, in order, for example, to achieve an improvement in the anchoring of the PSA. The side may also have been treated with a functional layer which may function, for example, as a barrier layer. The back face of the carrier may have been given a prior-art pretreatment for the purpose, for example, of achieving a release effect. The back face of the carrier may also be printed. The PSA can optionally be lined with a release paper or release film. The PSA has a typical layer thickness of between 1 μm and 2000 μm, preferably between 5 μm and 1000 μm.

Structure 3 is a double-sided pressure-sensitively adhesive product comprising as its middle layer, for example, a carrier film, a carrier paper, a textile fabric or a carrier foam. In structure 3, the top and bottom layers employed are inventive PSAs of like or different type and/or of like or different layer thickness. In this case the carrier may have been given a prior-art pretreatment on one or both sides in order, for example, to achieve an improvement in the anchoring of the PSA. It is likewise possible for one or both sides to have been treated with a functional layer, which may function, for example, as a barrier layer. The PSA layers may optionally be lined with release papers or release films. Typically the PSA layers independently of one another have layer thicknesses of between 1 μm and 2000 μm, preferably between 5 μm and 1000 μm.

As a further double-sided pressure-sensitively adhesive product, structure 4 is one variant of the invention. A PSA layer of the invention carries on one side a further PSA layer, which, however, may be of any desired kind and therefore need not be inventive. The structure of this pressure-sensitively adhesive product may optionally be lined with one or two release films or release papers. The PSA layers have layer thicknesses, independently of one another, of between typically 1 μm and 2000 μm, preferably between 5 μm and 1000 μm.

As in structure 4, structure 5 is also a double-sided pressure-sensitively adhesive product which comprises a PSA of the invention and also any desired further PSA. The two PSA layers in structure 5, however, are separated from one another by a carrier, a carrier film, a carrier paper, a textile fabric or a carrier foam. This carrier may have been given a prior-art pretreatment on one or both sides in order, for example, to achieve an improvement in the anchoring of the PSA. It is also possible for one or both sides to have been treated with a functional layer, which may function, for example, as a barrier layer. The PSA layers may optionally be lined with release papers or release films. The PSA layers have layer thicknesses, independently of one another, of between typically 1 μm and 2000 μm, preferably between 5 μm and 1000 μm.

The pressure-sensitively adhesive product of the invention in accordance with structure 6 comprises a layer of inventive material as a middle layer, which is provided on both sides with any desired PSAs of like or different kind. One or both sides of the middle layer may have been treated with a functional layer, which may function, for example, as a barrier layer. For the outer layers of PSA it is not necessary for inventive PSAs to be employed. The outer PSA layers may optionally be lined with release papers or release films. The outer PSA layers have layer thicknesses, independently of one another, of between typically 1 μm and 2000 μm, preferably between 5 μm and 1000 μm. The thickness of the middle layer is typically between 1 μm and 2000 μm, preferably between 5 μm and 1000 μm.

The pressure-sensitively adhesive products of the invention are employed with advantage in such a way that the structural anisotropy which exists within them is exploited for optical, electrical, electronic, optoelectronic, magnetic, thermal, mechanical and/or adhesives-related effects. They are preferably employed in the form of diecut objects or of self-adhesive tapes.

In the above part of this description it has been shown that the length of the melt web can be utilized, advantageously and in accordance with the invention, as a control variable for setting increased anisotropy in PSAs during coating. In the processing operation it can be advantageous to vary other operating parameters as well. One example that may be mentioned of such a parameter is the operating speed. Operating parameters of this kind may have an effect on the degree of anisotropy in PSAs that is generated in the operation. For constant product properties, however, it is necessary always to generate a uniform degree of anisotropy in the PSA. It is part of this invention to use the length of the melt web as a compensating variable, so that the PSA features the original degree of anisotropy despite changes made to other operating parameters. On the other hand, the length of the melt web can be used in order to generate different degrees of anisotropy while other operating conditions are otherwise constant—such as, for example, when the slot through which composition exits is constant.

In accordance with the invention, more particularly, pressure-sensitively adhesive products are provided where the anisotropic optical, electrical, electronic, optoelectronic, thermal, mechanical and/or adhesives-related properties of at least one layer, based on anisotropic PSAs, are exploited.

The invention is intended to be elucidated in more detail with reference to examples, but without being restricted thereto.

### WORKING EXAMPLES

Examples of the methods of the invention for generating high degrees of anisotropy in pressure-sensitive adhesives (PSAs) have been obtained by computer simulations, specifically by evaluating the results of finite element (FE) calculations. Simulations constitute experiments on a computer and are therefore comparable with experimental results. The simulation procedure is described below [see also T. Dollase et al., paper given to the PSTC TECH XXVII Global Conference, Orlando, 2004].

The basis for the simulations was the arithmetic approach developed by Feigl, Laso and Öttinger and published under the name CONNFFESSIT (Calculation of Non-Newtonian Flow: Finite Elements and Stochastic Simulation Techniqe) [K. Feigl, M. Laso, H. C. Öttinger, Macromolecules, 1995, 28, 3261]. Carrying out the calculations entails passing through seven stages. The first to count for this purpose is the definition of the design of the production operation under investigation, the operating parameters, and the nature of the materials to be operated on. Subsequently the rheological profile is recorded experimentally for the materials under investigation, as an input for the simulations. After that, the rheological data are matched to a specially selected constitutive equation system. Additionally, FE meshes are set up for the above-defined operating geometries. In combination with operating parameters such as temperature and throughput, temperature, velocity, and velocity-gradient fields are drawn up in these FE meshes by means of numerical calculations. Finally, it is possible to simulate a processing operation by a volume element of the PSA flowing through the velocity field and, during its passage, undergoing different temperatures and velocity gradients in accordance with its location in the operation. These external influences cause restructuring of the material in accordance with its rheological behavior. In the final step of the simulation, data are obtained for the anisotropy in the form of the molecular orientation and the chain stretching.

Presented below are two examples and one comparison example which are intended to illustrate and underscore the advantages of preferred embodiments of these inventions. For all three examples simulations were conducted in accordance with the process described above. Data on the rheology of the PSA system included dynamic mechanical analyses for the investigation of the linearly viscoelastic behavior under shear, and measurements relating to the steady-state flow behavior under shear, to the time-dependent flow behavior at the beginning of a new shearing stress, and also of the time-dependent flow behavior under extension. Further data, based on experimental determinations and input to the simulations as material parameters, were the temperature dependency of the density, of the thermal conductivity, and of the specific heat capacity. These data were matched to a constitutive equation system which is especially suitable for describing the nonlinear flow behavior of interentangled polymer melts [H. C. Öttinger, J. Rheol., 1999, 43, 1461; J. Fang, M. Kröger, H. C. Ottinger, J. Rheol., 2000, 44, 1293]. This gave the four material parameters G_{N}⁰, Z, T_{D}, and λₘₐₓ and also their temperature dependency.

When FE meshes had been drawn up for the desired operating geometries, and the temperature, velocity, and velocity gradient fields had been calculated, the actual FE simulations were commenced. This was done by considering a system containing 30 000 polymer chains and monitoring the system, in a simulative flow operation, to observe how the structure of this statistical collective changed during the operation, i.e., how anisotropy came about and relaxed. The statistical collective was placed in the center of the adhesive flow at the end of the adhesive supply line and in the entry region of the coating assembly. During the FE simulations, the collective moved along flow lines which resulted from the velocity fields calculated beforehand. The anisotropy, in the form of chain stretching and molecular orientation, was recorded incrementally at points along the flow lines. Critical values were those found for the various operations under investigation and for the PSA under investigation at the point of placement on the deposition medium (point 8 in FIG. 1). High values for molecular orientation and chain stretching indicate that high degrees of anisotropy are generated via the operating embodiment carried out, whereas low values imply that the operating embodiment employed leads only to a restricted extent, or not at all, to an anisotropic structure of the PSA.

In order to be able to quantify anisotropy and hence to be able to compare results from different operating procedures with one another, numerical data are required which give a numerical description of chain stretching and molecular orientation. Each of these two phenomena serves as a description variable, in each case independent in principle from the other, for anisotropy. Both of these phenomena follow the same trend, namely that a high amount implies a high degree of anisotropy.

The description of the chain stretching is effected in the one-chain model. For chain stretching in the equilibrium state the value λ=1 is defined. In this state the envelope of a polymer chain under consideration (an ellipsoid as shown in FIG. 2) is characterized by the semiaxis values a, b, and c, which in general have different values. Chain stretching causes deformation of the ellipsoid, and so the semiaxis values take on the amounts a′, b′, and c′. The most to which the chain can be stretched is as predetermined by the material parameter λₘₐₓ. The parameter λ, which describes the state of chain stretching, can therefore take on any values from 1 to λₘₐₓ.

Molecular orientation is quantified via the use of eigenvalues of the orientation tensor. The approach entails a multiple-chain model. In this model, for one collective, the alignment of all the ellipsoids is averaged and investigated for any average preferential direction. The orientation tensor is spread, if deformation occurs in the machine direction, by three eigenvectors, which lie substantially parallel to the machine direction, parallel to the transverse direction, and parallel to the normal direction, respectively. The ratio Ω formed from the eigenvalue that describes the amount of the eigenvector along the machine direction and the eigenvalue that expresses the amount of the eigenvector along the transverse direction is a quantitative measure of molecular orientation. The value of Ω adopts values from 1 in the isotropic state to ∞ (infinity) in the fully oriented state.

### COMPARISON EXAMPLE

A resin-free polyacrylate according to DE 39 42 232 was coated at 170° C. onto a siliconized release paper, using an extrusion die having a coathanger manifold with a working width of 350 mm. The die slot measured 300 μm and the length of the die lip was 60 mm. The web velocity was 50 m/min, the mass application was 75 g/m² and the throughput 73 kg/h. The length of the melt web was 40 mm.

### EXAMPLE 1

A polyacrylate as also employed in the Comparison Example was coated at 170° C. onto a siliconized release paper, using an extrusion die having a coathanger manifold with a working width of 350 mm. The die slot again measured 300 μm and the length of the die lip was 60 mm. The web velocity was 50 m/min, the mass application was 75 g/m², and the throughput was 73 kg/h. The length of the melt web was 20 mm.

### EXAMPLE 2

A polyacrylate as also employed in the Comparison Example and in Example 1 was coated at 170° C. onto a siliconized release paper, using an extrusion die having a coathanger manifold with a working width of 350 mm. The die slot again measured 300 μm and the length of the die lip was 60 mm. The web velocity was 50 m/min, the mass application was 75 g/m², and the throughput was 73 kg/h. The length of the melt web was 80 mm.

For the two examples and the comparative example, the ratio Γ was calculated and the data, obtained in the simulation, for the chain stretching ? and orientation Ω at the point 8 (see FIG. 1) were plotted. The values are compiled in Table 2.

TABLE 2

| | | Chain | |
|---|---|---|---|
| | Ratio Γ | stretching λ | Orientation Ω |
| Comparison | 0.005 s² | 1.60 | 6.1 |
| Example | | | |
| Example 1 | 0.002 s² | 1.63 | 6.4 |
| Example 2 | 0.020 s² | 1.62 | 6.5 |

The examples show that a ratio Γ modified, in accordance with the invention, through the operation, in comparison to the reference regime, leads, through the inventive selection of process parameters, to increased anisotropy in the PSA investigated, in two ways. In Example 1, to underline one advantageous embodiment of this invention, the length of the melt web was reduced inventively, relative to the reference, to 20 mm. This produced a higher draw rate and, consequently, an inventively low ratio Γ of 0.002 s². By means of this embodiment of the coating operation it is possible to improve not only chain stretching but also molecular orientation. The second advantageous embodiment of this invention becomes clear in Example 2. In contrast to the comparative, the length of the melt web was this time increased, inventively, to 80 mm. This resulted in an increase in the activity time, and the ratio Γ rose to an inventively high level of 0.020 s². Here again, as in Example 1, although realized in a different way this time, but also inventively, the result is increased amounts of chain stretching and molecular orientation.

### LIST OF REFERENCE NUMERALS

1 adhesive supply line
2 applicator mechanism or coating assembly
3 melt web
4 cooling roll
5 optionally employable, separately supplied deposition medium
6 optionally employable crosslinking station
7 exit slot
8 point of placement

1-27. (canceled)

27. A method for producing high-anisotropy pressure-sensitive adhesives (PSAs),
comprising providing as operating elements an adhesive supply system,
providing an applicator mechanism,
providing a deposition element,
forming, between an exit of the applicator mechanism and point of placement on the deposition element, a free melt web of the PSA, which undergoes a draw operation,
controlling the drawing of the PSA in the free melt web via an activity ratio Γ which is characterized as the ratio of activity time Δt in the draw operation to the draw rate R, and which is set to a level of at least 0.006 s², the activity time Δt being defined by the formula 2Lr/[v_{web}(1+r)], in which L is the length of the melt web, r is the draw ratio, and v_{web} is the velocity of the melt web, and the draw rate R is defined as the time derivation of the draw ratio r.

28. The method of claim 27, wherein the activity ratio Γ is set to a level of at least 0.006 s², preferably to a level of at least 0.008 s².

29. The method of claim 27, wherein for the PSA in the melt web the ratio Γ is realized such that the length of the melt web is high and is at least 40 mm, preferably at least 75 mm, very preferably at least 100 mm.

30. The method of claim 27, wherein the activity ratio Γ is set to a level of not more than 0.004 s², preferably to a level of not more than 0.002 s².

31. The method of claim 27, wherein for the PSA in the melt web the ratio Γ is realized such that the length of the melt web is low and is not more than 40 mm, preferably not more than 25 mm, very preferably not more than 15 mm.

32. The method of claim 27, wherein the activity time Δt has a value of at least 0.01 s, preferably at least 0.1 s, more preferably of at least 0.25 s.

33. The method of claim 27, wherein the PSA in the melt web is subjected to a draw rate R of at least 1 s⁻¹.

34. The method of claim 27, wherein the draw ratio r of the PSA in the melt web, which is defined by D/d=v_{web}/v₀, where D is the height of the exit slot of the applicator mechanism and d is the layer thickness of the PSA film deposited on the deposition element, and v₀ is the velocity at the exit slot, is at least 2:1.

35. The method of claim 27, wherein the height of the exit slot, D, is at least 150 μm.

36. The method of claim 27, wherein the layer thickness d of PSAs is preferably between 1 μm and 2000 μm, more preferably between 5 μm and 1000 μm.

37. The method of claim 27, wherein the coating temperature is between at least 25° C. and not more than 250° C., preferably between at least 50° C. and not more than 200° C.

38. The method of claim 27, wherein the PSA film, after it has left the applicator mechanism, is cooled, preferably by passage of a cooling medium of any desired kind and/or of a cooling assembly of any desired kind.

39. The method of claim 38, wherein cooling is performed using a cooling roll which is operated at a temperature of not more than 60° C., preferably of not more than 30° C.

40. The method of claim 27, wherein adhesive supply systems used are those which, either individually or in combination, effect, on demand, sufficient softening or at least heating and conveying of preferably solvent-free hot-melt PSAs, preferably drum melting systems, premelters and/or extruders, coupled, where appropriate, with melt pumps.

41. The method of claim 27, wherein as applicator mechanism a coating unit is used which, as a contactless process, forms a melt web.

42. The method of claim 41, wherein deposition media used are preferably roller or roll elements which are suitable for guiding a product web, it being possible for the point of placement to be situated either at each surface point of an individual cylindrical element or in the nip between two roll elements, and the free PSA film either being placed directly onto a carrier material or being first transferred to a suitable antiadhesive surface and only in the subsequent course of operation being transferred to a carrier material.

43. The method of claim 27, wherein, after the PSA film has been placed on the deposition medium, it is dried preferably in a drying tunnel.

44. The method of claim 27, wherein the coating step is followed by crosslinking of the anisotropic PSA, the crosslinking operation taking place preferably not more than 25 s after the placement of the PSA film on the deposition medium, very preferably not more than 10 s after the placement of the PSA film on the point of placement, preferably by means of UV radiation, electron beams and/or thermal energy.

45. The method of claim 27, wherein during the coating step, the anisotropic PSA is crosslinked, preferably by means of UV radiation, electron beams and/or thermal energy.

46. The method of claim 27, wherein under the operating conditions, on exit from the applicator mechanism, the PSAs constitute nonewtonian fluids having a structurally viscous character.

47. The method of claim 27, wherein the PSA is of linear, branched, grafted design, is preferably a homopolymer, random copolymer or block copolymer, has a molar mass of at least 100 000 g/mol.

48. The method of claim 27, wherein the a homopolymer, random copolymer or block copolymer, has a molar mass of at least 500 000 g/mol.

49. The method of claim 27, wherein the PSAs comprise further constituents such as resins, plasticizers, additives with rheological activity, catalysts, initiators, stabilizers, compatibilizers, coupling reagents, crosslinkers, antioxidants, other aging inhibitors, light stabilizers, flame retardants, pigments, dyes, fillers and/or expandants and also, optionally, solvents.

50. A pressure-sensitively adhesive product comprising at least one layer based on anisotropic PSAs produced in accordance with claim 27.

51. A method of adjusting a defined anisotropy in pressure-sensitive adhesives (PSAs) in the course of their production, comprising as operating elements a mass supply system, an applicator mechanism, and a deposition element, there being formed, between the exit of the applicator mechanism and point of placement on the deposition element, a free melt web of the PSA, which undergoes a draw operation,
comprising the step of
controlling the drawing of the PSA in the free melt web via an activity ratio Γ which is characterized as the ratio of activity time Δt in the draw operation to the draw rate R, the activity time Δt being defined by the formula 2Lr/[v_{web}(1+r)], in which L is the length of the melt web, r is the draw ratio, and v_{web} is the velocity of the melt web, and the draw rate R is defined as the time derivation of the draw ratio r.

52. The method of claim 51, wherein the length of the free melt web is used as control variable to ensure high anisotropies.

53. The method of claim 51, wherein, in order to ensure high anisotropies, a high draw ratio of the free melt web is used as control variable.

54. The method of claim 33, wherein the draw rate R is at least 10 s⁻¹.

55. The method of claim 33, wherein the draw rate R is at least 25 s⁻¹.

56. The method of claim 34, wherein v₀ the velocity at the exit slot is at least 4:1.

57. The method of claim 34, wherein v₀ the velocity at the exit slot is at least 6:1.

58. The method of claim 35, wherein the height of the exit slot, D, is at least 300 μm.

59. The method of claim 35, wherein the height of the exit slot, D, is at least 600 μm.

60. The method of claim 36, wherein the layer thickness d of PSAs is between 1 μm and 2000 μm.

61. The method of claim 36, wherein the layer thickness d of PSAs is between 5 μm and 1000 μm.

62. The method of claim 37, wherein the coating temperature is between at least 50° C. and not more than 200° C.

63. The method of claim 39, wherein the cooling roll is operated at a temperature of not more than 30° C.

64. The method of claim 41, wherein the coating unit forms slot dies. such as, for example, extrusion dies or curtain-coating dies such as casting dies, for example.

65. The method of claim 41, wherein the coating unit forms extrusion dies, curtain-coating dies or casting dies.

66. The method of claim 47, wherein the PSA has a softening temperature of not more than 20° C.
